(19) United States
(12) Patent Application Publication
(10) Pub. No.: US 2026/0132061 A1
(43) Pub. Date: May 14, 2026

(54) WATER-DECONTAMINATION CELL USING ALTERNATING LAYERS OF ELECTRODES

(71) Applicants: Artem Lavrentev, Edmonton (CA); Eric Beaulieu, Edmonton (CA); Richard H. Smith, Edmonton (CA); Robert Ippolito, Edmonton (CA)

(72) Inventors: Artem Lavrentev, Edmonton (CA); Eric Beaulieu, Edmonton (CA); Richard H. Smith, Edmonton (CA); Robert Ippolito, Edmonton (CA)

(21) Appl. No.: 19/196,131

(22) Filed: May 1, 2025

Related U.S. Application Data
(63) Continuation-in-part of application No. 16/682,870, filed on Nov. 13, 2019, now abandoned.

(51) Int. Cl. C02F 1/467

(52) U.S. Cl. CPC C02F 1/4672; C02F 1/4676; C02F 2201/002; C02F 2201/4611; C02F 2201/4614

(57) ABSTRACT

A system and method for the removal and oxidation/reduction of contaminants from water in the absence of substantial oxidative/reductive chemicals includes:

a volume within a solid housing in which concentrations of contaminants are moderated from contaminated water, and b) within the housing an enclosed direction for water flow from a water entry side to a water exit side of the housing;

within the housing is a core with c) a spiral wound pair of porous conductive fibrous layers such as leafed carbon felt layers of at least two different thicknesses acting as at least one set of electrodes as at least one pair of anodes and cathodes having an axis within the spiral wound pair, and

the distribution of the spiral wound pair of leafed carbon felt layers within the housing creating water flow paths in three directions.

### RELATED APPLICATIONS DATA SECTION

This application claims priority under 35 USC 120 as a Continuation-in-Part of U.S. patent application Ser. No. 16/682,870, filed Nov. 13, 2019, which is in turn a Continuation of U.S. patent application Ser. No. 15/693,861, filed Sep. 1, 2017.

### BACKGROUND OF THE INVENTION

### 1. Field of the Invention

This invention relates to water and wastewater treatment technologies for collection, decomposition or destruction of molecular pollutants, including micropollutants.

### 2. Background of the Art

Activated carbon, also called activated charcoal or activated coal is a form of carbon that has been processed to make it extremely porous and thus to have a very large surface area available for adsorption or chemical reactions. The carbon may be provided by many different processes and in many of the various forms of carbon available, such as powdered carbon, expanded carbon, graphite, expanded graphite and the like.

The word activated in the name is sometimes replaced with active. Due to its high degree of microporosity, just 1 gram of activated carbon has a surface area in excess of 500 m² (about one tenth the size of an American football field), as determined typically by nitrogen gas adsorption. Sufficient activation for useful applications may come solely from the high surface area, though further chemical treatment often enhances the adsorbing properties of the material. Activated carbon is usually derived from charcoal.

Activated carbon is carbon produced from carbonaceous source materials such as, by way of non-limiting examples, nutshells, peat, wood, coir, lignite, coal and petroleum pitch. It can be produced by one of the following non-limiting processes:
1. Physical reactivation: The precursor is developed into activated carbons using gases. This is generally done by using one or a combination of the following processes:
Carbonization: Material with carbon content is pyrolyzed at temperatures in the range 600-900° C., in absence of oxygen (usually in inert atmosphere with gases like argon or nitrogen)
Activation/Oxidation: Raw material or carbonized material is exposed to oxidizing atmospheres (carbon monoxide, oxygen, or steam) at temperatures above 250° C., usually in the temperature range of 600-1200° C.
2. Chemical activation: Prior to carbonization, the raw material is impregnated with certain chemicals. The chemical is typically an acid, strong base, or a salt (phosphoric acid, potassium hydroxide, sodium hydroxide, zinc chloride, respectively). Then, the raw material is carbonized at lower temperatures (450-900° C.). It is believed that the carbonization/activation step proceeds simultaneously with the chemical activation. Chemical activation is preferred over physical activation owing to the lower temperatures and shorter time needed for activating material.

Activated carbons are complex products which are difficult to classify on the basis of their behavior, surface characteristics and preparation methods. However, some broad classification is made for general purpose based on their physical characteristics. They may be formally or informally characterized according to properties, method of production, morphology and/or other factors.

One form of activated carbon is known as powdered activated carbon (PAC). Activated charcoal under bright field illumination on a light microscope displays a fractal-like shape of the particles hinting at their enormous surface area. Each particle despite being only around 0.1 mm wide, has a surface area of several square meters.

Traditionally, active carbons are made in particulate form as powders or fine granules less than 1.0 mm in size with an average diameter between 0.15 and 0.25 mm. Thus they present a large surface to volume ratio with a small diffusion distance. PAC is made up of crushed or ground carbon particles, 95-100% of which will pass through a designated mesh sieve or sieve. Granular activated carbon is defined as the activated carbon being retained on a 50-mesh sieve (0.297 mm) and PAC material as finer material, while ASTM classifies particle sizes corresponding to an 80-mesh sieve (0.177 mm) and smaller as PAC. PAC is not commonly used in a dedicated vessel, owing to the high head loss that would occur. PAC is generally added directly to other process units, such as raw water intakes, rapid mix basins, clarifiers, and gravity filters.

Granular activated carbon is another form of activated carbon that has a relatively larger particle size compared to powdered activated carbon and consequently, presents a smaller external surface. Diffusion of the adsorbate is thus an important factor. These carbons are therefore preferred for all adsorption of gases and vapors as their rate of diffusion are faster. Granulated carbons are used for water treatment, deodorization and separation of components of flow system. GAC can be either in the granular form or extruded. GAC is designated by sizes such as 8×20, 20×40, or 8×30 for liquid phase applications and 4×6, 4×8 or 4×10 for vapor phase applications. A 20×40 carbon is made of particles that will pass through a U.S. Standard Mesh Size No. 20 sieve (0.84 mm) (generally specified as 85% passing) but be retained on a U.S. Standard Mesh Size No. 40 sieve (0.42 mm) (generally specified as 95% retained). AWWA (1992) B604 uses the 50-mesh sieve (0.297 mm) as the minimum GAC size. The most popular aqueous phase carbons are the 12.times.40 and 8.times.30 sizes because they have a good balance of size, surface area, and head loss characteristics.

Extruded activated carbon is another form that combines powdered activated carbon with a binder, which are fused together and extruded into a cylindrical shaped activated carbon block with diameters from 0.8 to 130 mm. These are mainly used for gas phase applications because of their low pressure drop, high mechanical strength and low dust content.

Impregnated carbon is a porous carbon containing several types of inorganic impregnant such as iodine (halogens and halogen ions), atomic, atomic aggregates, or nanoparticles of metal, silver, cations such as Al, Mn, Zn, Fe, Li, Ca have also been prepared for specific application in air pollution control especially in museums and galleries. Due to antimicrobial/antiseptic properties, silver loaded activated carbon is used as an adsorbent for purification of domestic water. Drinking water can be obtained from natural water by treating the natural water with a mixture of activated carbon and Al(OH).sub.3, a flocculating agent. Impregnated carbons are also used for the adsorption of H₂S and thiols. Adsorption rates for H₂S as high as 50% by weight have been reported.

Activated carbon is also available in special forms such as cloths and fibers. The “carbon cloth” for instance is used in personnel protection for the military.

A gram of activated carbon can have a surface area in excess of 500 m², with 1500 m² being readily achievable. Carbon aerogels, while more expensive, have even higher surface areas, and are used in special applications.

Under an electron microscope, the high surface-area structures of activated carbon are revealed. Individual particles are intensely convoluted and display various kinds of porosity; there may be many areas where flat surfaces of graphite-like material run parallel to each other, separated by only a few nanometers or so. These micropores provide superb conditions for adsorption to occur, since adsorbing material can interact with many surfaces simultaneously. Tests of adsorption behavior are usually done with nitrogen gas at 77 K under high vacuum), but in everyday terms activated carbon is perfectly capable of producing the equivalent, by adsorption from its environment, liquid water from steam at 100° C. and a pressure of 1/10,000 of an atmosphere.

Physically, activated carbon binds materials by van der Waals force or London dispersion force. Activated carbon does not bind well to certain chemicals, including alcohols, glycols, strong acids and bases, metals and most inorganics, such as lithium, sodium, iron, lead, arsenic, fluorine, and boric acid. Activated carbon does adsorb iodine very well and in fact the iodine number, mg/g, (ASTM D28 Standard Method test) is used as an indication of total surface area. Ammonia adsorption on activated carbon is both temperature and concentration dependent, directly, in aqueous liquids.

Carbon monoxide is not well absorbed by activated carbon. This should be of particular concern to those using the material in filters for respirators, fume hoods or other gas control systems as the gas is undetectable to the human senses, toxic to metabolism and neurotoxic.

Activated carbon can be used as a substrate for the application of various chemicals which improve the adsorptive capacity for some inorganic (and problematic organic) compounds such as hydrogen sulfide (H₂S), ammonia (NH₃), formaldehyde (HCOH), radioisotopes iodine-1³¹ and mercury (Hg). This property is known as chemisorption.

Iodine Number—Many carbons preferentially adsorb small molecules. Iodine number is the most fundamental parameter used to characterize activated carbon performance. It is a measure of activity level (higher number indicates higher degree of activation), often reported in mg/g (typical range 500-1200 mg/g). It is a measure of the micropore content of the activated carbon (0 to 20 Angstroms or up to 2 nm) by adsorption of iodine from solution. It is equivalent to surface area of carbon between 900m²/g and 1100 m²/g. It is the standard measure for liquid phase applications.

Iodine number is defined as the milligrams of iodine adsorbed by one gram of a material such as carbon, organic materials (such as oils, lipids, hydrocarbons, carbohydrates, etc.) when the iodine concentration in the residual filtrate is 0.02 normal. Basically, iodine number is a measure of the iodine adsorbed in the pores and, as such, is an indication of the pore volume available in the activated carbon of interest. Typically, water treatment carbons have iodine numbers ranging from 600 to 1100. Frequently, this parameter is used to determine the degree of exhaustion of a carbon in use. However, this practice should be viewed with caution as chemical interactions with the adsorbate may affect the iodine uptake giving false results. Thus, the use of iodine number as a measure of the degree of exhaustion of a carbon bed can only be recommended if it has been shown to be free of chemical interactions with adsorbates and if an experimental correlation between iodine number and the degree of exhaustion has been determined for the particular application. Although carbon is primarily described herein, any other surface on a material (porous or not) may also be used as long as it can sustain or provide an iodine number of at least 100 mg/g. Silicone materials, polymers, composites, coated substrates (such as carbon coated, or graphite coated substrates) and the like are examples thereof. These materials are preferably porous or microporous to allow high surface areas per volume of material.

Dechlorination—Some carbons are evaluated based on the dechlorination half-value length, which measures the chlorine-removal efficiency of activated carbon. The dechlorination half-value length is the depth of carbon required to reduce the chlorine level of a flowing stream from 5 ppm to 3.5 ppm. A lower half-value length indicates superior performance.

Ash Content—Ash content reduces the overall activity of activated carbon. It reduces the efficiency of reactivation. The metal oxides (Fe₂O₃) can leach out of activated carbon resulting in discoloration. Acid/water soluble ash content is more significant than total ash content.

Soluble ash content can be very important for aquarists, as ferric oxide can promote algal growths. A carbon with a low soluble ash content should be used for marine, freshwater fish and reef tanks to avoid heavy metal poisoning and excess plant/algal growth.

Carbon Tetrachloride Activity—Measurement of the porosity of an activated carbon by the adsorption of saturated carbon tetrachloride vapor.

Particle Size Distribution—The finer the particle size of an activated carbon, the better the access to the surface area and the faster the rate of adsorption kinetics. In vapor phase systems this needs to be considered against pressure drop, which will affect energy cost. Careful consideration of particle size distribution can provide significant operating benefits.

The most commonly encountered form of chemisorption in industry, occurs when a solid catalyst interacts with a gaseous feedstock, the reactant/s. The adsorption of reactant/s to the catalyst surface creates a chemical bond, altering the electron density around the reactant molecule and allowing it to undergo reactions that would not normally be available to it.

Carbon adsorption has numerous applications in removing pollutants from air or water streams both in the field and in industrial processes such as: Spill cleanup; Groundwater remediation; Drinking water filtration; Air purification; Volatile organic compounds capture from painting, dry cleaning, gasoline dispensing operations, and other processes.

Activated charcoal is also used for the measurement of radon concentration in air. Activated carbon is also used as growth media in biologic methods of water and wastewater treatment. U.S. patent application Ser. No. 15/233,693, filed 10 Aug. 2016 and Titled “Electrochemical Decontamination Cells” describes a method and system generates reductive and/or oxidative chemical species in an aqueous fluid stream to disinfect and remove contamination by:
a) providing a filter material comprising at least one a porous carbon support layer and a silicate/glass wool layer;
b) passing an electric current through the filter material;
c) passing a fluid stream containing elemental halogens and/or halide salts through the filter material, distributing halogens or halides within the filter material;
d) directing a contaminated fluid mass into contact with the filter material in the presence of the electric current; and
e) adsorbing contaminants from the fluid mass onto the filter material disinfecting or removing the contaminants.

U.S. Pat. No. 7,850,764 (DeBerry) describes removal of contaminants from vapor streams and incidentally discloses regeneration of the filter media by heating the used activated carbon, especially to release bound mercury or by using a complexing agent to reduce or oxidize the bound mercury and make it available for removal.

U.S. Pat. No. 7,736,611 (Norberg) discloses filter materials that are regenerate by heating or vapor flushing, including activated carbon filters.

U.S. Pat. No. 7,442,352 (Lu) discloses uses for removing contaminants using activated carbon and regenerating the activated carbon by thermal degassing or washing out of the gases. U.S. Pat. No. 6,953,494 (Nelson) teaches the use o bromine gas in activated carbon to improve its ability o adsorb mercury from combustion emission.

U.S. Pat. No. 6,638,347 (El-Shoubary) discloses carbon-based, adsorption powder containing an effective amount of cupric chloride suitable for removing mercury from a high temperature, high moisture gas stream, wherein the effective amount of cupric chloride ranges from about 1 to about 45 wt percent. Additional additives, such as potassium permanganate, calcium hydroxide, potassium iodide and sulfur, may be added to the powder to enhance the removal of mercury from the gas stream.

All references cited herein, including the [priority documents, are incorporated by reference in their entireties. Each and every document identified herein is incorporated by reference in their entirety,

### SUMMARY OF THE INVENTION

A method and system for the removal and oxidation/reduction of contaminants from water in the absence of substantial oxidative/reductive chemicals comprising:
a solid housing;
the housing providing a) a volume within which concentrations of contaminants are moderated from contaminated water, and b) within the housing an enclosed direction for water flow from a water entry side to a water exit side of the housing;
within the volume of the housing is a core comprising c) a spiral wound pair of leafed carbon felt layers of at least two different thicknesses acting as at least one set of electrodes as at least one pair of anodes and cathodes having an axis within the spiral wound pair, and within two distinct and opposed areas of the spiral wound pair of porous, conductive layers, such as carbon felt layers d) the at least one pair of anodes and cathodes passing longitudinally from the water entry side to the water exit side; all of this comprising the core.
the spiral wound pair of leafed carbon felt layers having multiple current distributors within the spiral wound pair of leafed carbon felt layers are configured to distribute an even electric potential and/or field across the spiral wound pair of leafed carbon felt layers; the distribution being longitudinally and/or radially within the carbon felt layers.
the housing having restraining walls surrounding the spiral wound pair of carbon felt layers, and having the water entry side and the water exit side at positions at ends of the axis of the spiral wound pair of leafed carbon felt layers; and
the distribution of the spiral wound pair of leafed carbon felt layers within the housing creating water flow paths in three directions, i) parallel to the axis from the water entry side towards the water exit side; ii) radially outwardly from the axis towards the restraining walls; and iii) radially inwardly from the restraining walls towards the axis.

### BRIEF DESCRIPTION OF THE DRAWINGS

FIG. 1A is a schematic of a Source-Sink alignment for an example of a system for technology useful in the practice of the present invention.

FIG. 1B is a schematic of a Source-Sink alignment as an example of a system for technology useful in the practice of the present invention using flow directing baffles.

FIG. 2A is a schematic of an assembly showing an electrode roll with current distributors and collectors useful in the practice of the present invention.

FIG. 2B is a schematic of a perspective of an assembly showing an electrode roll with current distributors and collectors useful in the practice of the present invention.

FIG. 3A is a graph of Voltage versus voltage distribution around a thick roll at 4 Volts, with the different configurations shown in the key.

FIG. 3B is an image of a first varying distribution of electrodes and/or rods within an exemplary spiral wound system of the present technology.

FIG. 3C is an image of a second varying distribution of electrodes and/or rods within an exemplary spiral wound system of the present technology.

FIG. 4A is a graph evidencing resistance of the cell with 1 CD (current distributor) placed at increasingly further points along the electrode roll.

FIG. 4B is a schematic of a) Current distributor positions in the thick electrode roll, b) Voltage distribution curves for anode and cathode rolls at an applied 4 V. This can be utilized for any electrode length.

FIG. 5 is a graphic representation of the effect of the present technology on PFAS (specifically perfluoroctylacrylate) mediation.

### DETAILED DESCRIPTION OF THE INVENTION

A method and system for the removal and oxidation/reduction of contaminants from water in the absence of substantial oxidative/reductive chemicals comprising:
a solid housing;
the housing providing a) a volume within which concentrations of contaminants are moderated from contaminated water, and b) within the housing an enclosed direction for water flow from a water entry side to a water exit side of the housing;
within the volume of the housing is a core comprising c) a spiral wound pair of porous, conductive layers, preferably fibrous layers, such as leafed carbon felt layers of at least two different thicknesses acting as at least one set of electrodes as at least one pair of anodes and cathodes having an axis within the spiral wound pair, and within two distinct and opposed areas of the spiral wound pair of carbon felt layers d) the at least one pair of anodes and cathodes passing longitudinally from the water entry side to the water exit side; all of this comprising the core.
the spiral wound pair of leafed carbon felt layers having multiple current distributors within the spiral wound pair of leafed carbon felt layers are configured to distribute an even electric potential and/or field across the spiral wound pair of leafed carbon felt layers; the distribution being longitudinally and/or radially within the carbon felt layers.

In the statements and disclosure of this invention, the porous, conductive layers are typically referred to as carbon felt layers or leafed carbon felt layers. The specific description of carbon felt layers is generally used as a convenience so that the full range of useful materials for that porous, conductive layers do not have to be repeatedly recited. The appearances of the terms leafed carbon felt layer(s) or carbon felt layer are merely exemplary of the generic concept of porous, conductive layers. The generic term of porous conductive layers includes the use of any other structure similar to the carbon felt structure, such as non-woven, metallic fibers (or filaments), non-woven conductively doped fibers, structures of non-conductive fibers with conductive coatings thereon, and even reticulated foams (conductive or not) with conductive surfaces (e.g., the foam composition is itself conductive or a conductive coating is deposited thereon). The positive electrode layers should also be resistant to oxidative ions/molecules generated by the current on the positive electrodes. Metallic fibers (or metallic coated fibers) such as with elemental metals, platinum, silver alloys (alloys used to reduce the reactivity of silver), gold, nickel-ferrites, stainless steel, etc. can be used in the electrode (particularly cathode) as the fiber, the fiber substrate, or the fiber coating. SA broader range of conductive fiber materials may be used as the negative electrode (the anode) because the highly reactive oxidative species are not generated at that electrode, and the materials of the fiber need not be as resistant to such redox activity. In addition to the above described (structurally) conductive materials, including the carbon felt, tungsten titanium, copper, bronze, boron-doped zirconium, brass, stainless steel, iron, etc. may be used.

It is desirable that the individual layers be compressive (defined as being compressible by at least 5% without losing elastic memory), and flexible (flexibility being defined as being windable about a 1.0 meter diameter cylinder without losing elastic memory). The porosity of the material should be from 20%-80% by volume of open space. This open space may include matrix materials (e.g., pyrolytic carbon matrix generated during manufacture of the felt, binding agents, such as metallic, ceramic or silicone materials). Preferably the open space may constitute 40-80%, and more preferably from 80-60% of the uncompressed volume of the porous, conductive layers, such as the carbon felt layers discussed above).

The housing typically has restraining walls surrounding the spiral wound pair of carbon felt layers, and having the water entry side and the water exit side at positions at ends of the axis of the spiral wound pair of leafed carbon felt layers; and the distribution of the spiral wound pair of leafed carbon felt layers within the housing creating water flow paths in three directions, i) parallel to the axis from the water entry side towards the water exit side; ii) radially outwardly from the axis towards the restraining walls; and iii) radially inwardly from the restraining walls towards the axis.

Although spiral winding is preferred, the system may be alternatively constructed with layered elements stacked perpendicularly to the direction of flow. The system may be configured wherein the at least one set of electrodes are connected to an alternating current or direct current source. The system may further be configured wherein multiple current collectors comprising conductive elements are distributed within the spiral wound pair of leafed carbon felt layers to assist in distributing an even electric potential and field longitudinally and/or radially across the spiral wound pair of leafed carbon felt layers. The system may be further constructed wherein there is at least one current distributor on an anode for each two pairs of carbon felt layers, and preferable at least one distributor on a cathode for each two pairs of carbon felt layers. There may also be at least one anode-cathode current distributor pair for at least 80% of adjacent pairs of carbon felt layers, or there is at least one pair of anode and cathode current distributors for each pair of two carbon felt layers. The system may have at least two anode and cathode current distributors for each pair of carbon felt layers, and there may be baffles present within the housing to control direction of flow of contaminated water through the housing.

More specifically, an electrified spiral wound filter consisting of a separator and two continuous flow-through electrodes. The electrodes (and anode and a cathode) are given an applied potential, can maintain an even electric potential and field across their entirety using multiple current distributors and collectors (CD and CC), negating electric gradients as well as reducing the number of possible parasitic electrochemical side reactions and thus electrochemical byproducts in a variety of water matrices. This invention gives the ability to produce strong oxidizing agents such as hydroxyl radicals as well as others in a controlled setting without the need for any chemical precursors (e.g., such as halogens, H2O2 and other low molecular weight (less than 500 MW) oxidizing and or reducing agents.

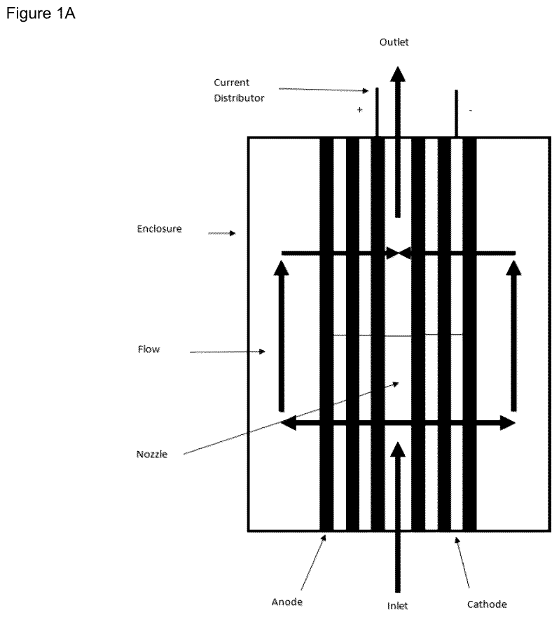

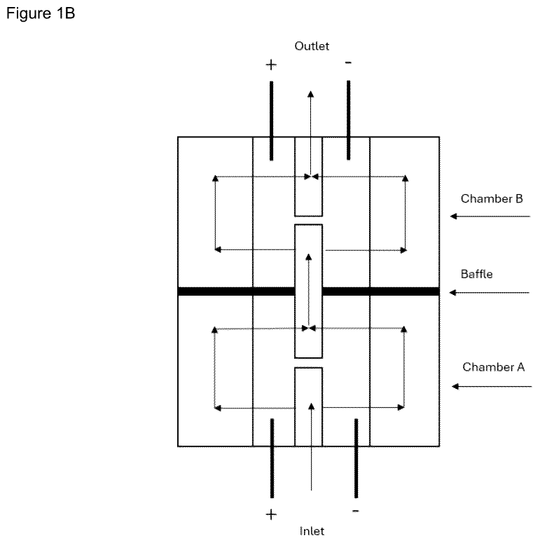

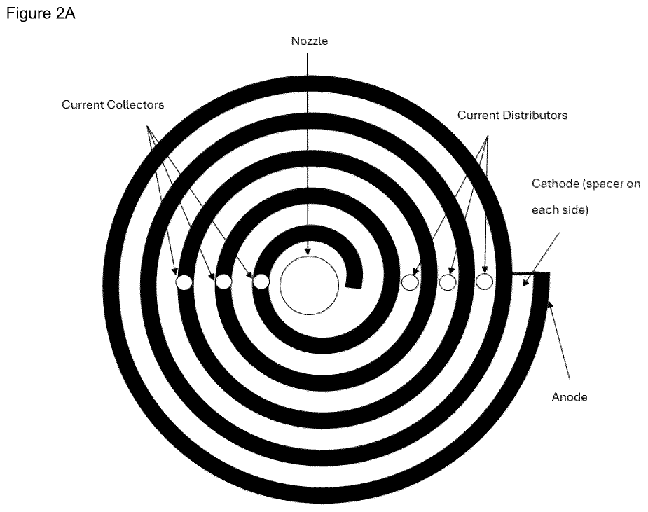

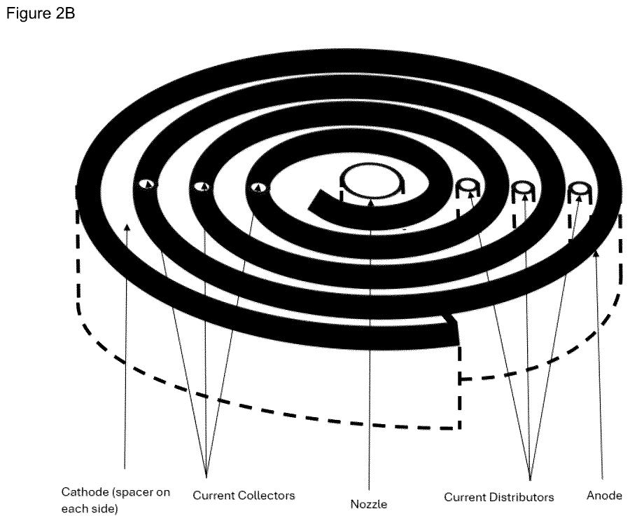

Furthermore, a new source-sink configuration may be constructed such as to have 1 or more chambers (See FIG. 1). The result is an increased probability of oxidizing agent production, increased residence time for micropollutant breakdown and enhanced efficiency all while reducing space requirements. An example of the device is provided in FIG. 2.

### 2. Problems Being Addressed (State of the Art)

Residence Time: Available treatments (like Ozone) require construction of pools, ozone generation, and subsequent treatment require a batch operation due to higher residence time requirement and efficiency.
Byproducts: Bromate which is toxic and suspected as carcinogen can be a product during ozonation.
Chemical Precursor: UV-Hydrogen peroxide systems require hydrogen peroxide dosing.
Regeneration: Powdered Activated Carbon (PAC) and Granular Activated Carbon (GAC) require periodic regeneration and disposal of spent carbon containing micropollutants. Typically done through incineration or with a digestor.
Reject: Membrane technologies such as Reverse Osmosis produce varying amounts of reject still need disposal like PAC or GAC.
Energy and Cost: All available technologies are significantly more expensive.

### 3. Summary of the Invention's Novelty

### 1. Residence Time

The system establishes a Source-Sink Configuration in One or Multiple Chambers: Provides an enhanced space and time optimization increasing treatment efficiency. Passes through Anode and Cathode more times increasing the probability of a necessary electrochemical reaction to occur. While giving more residence time and probability for the oxidizing agent to break down the micropollutant.

### 2. No Chemical Precursor Requirement

The system does not require any chemical injection, generates oxidizing agents electrochemically in-situ needing only water.

### 3. Controlled and Enhanced Electrical Potential Distribution

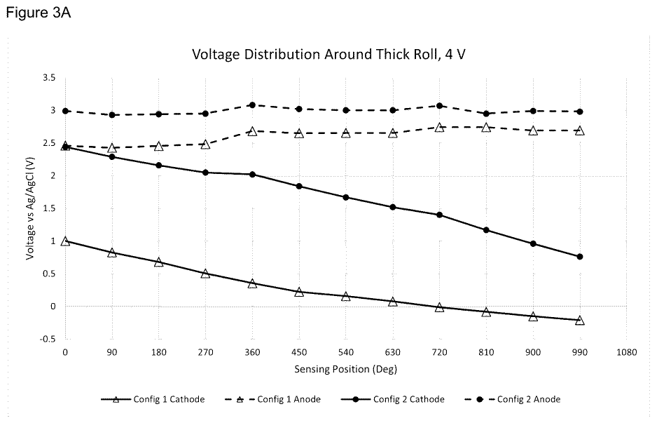

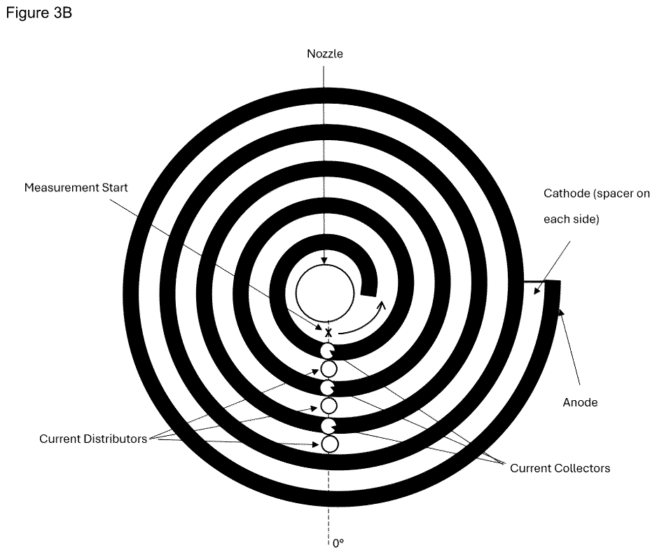

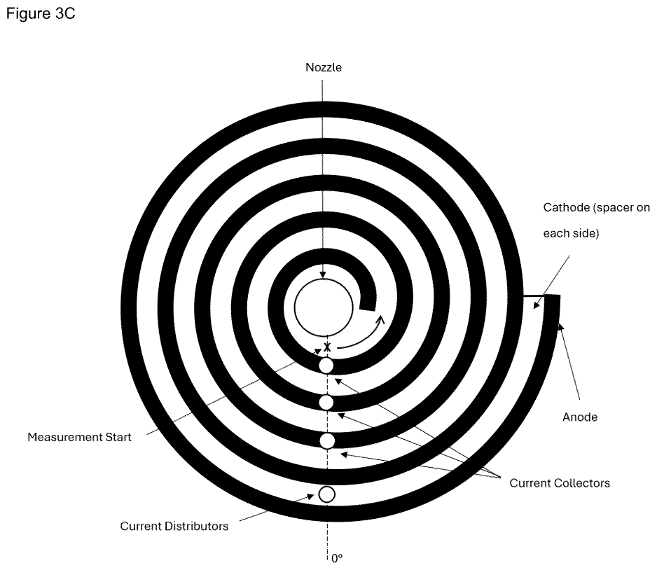

The system has an electrochemically active portion of the device which is comprised of two carbon felt pieces rolled together into a spiral pattern which contains a separator (See FIG. 3). One of the felt spirals is the anode and the other is the cathode. To apply electricity to the electrodes current distributors and current collectors are used which are metal rods stuck into each spiral. These rods are coated with a catalyst, so they also are active in the electrochemical process of producing oxidizing species.

FIG. 3: AOS electrode roll

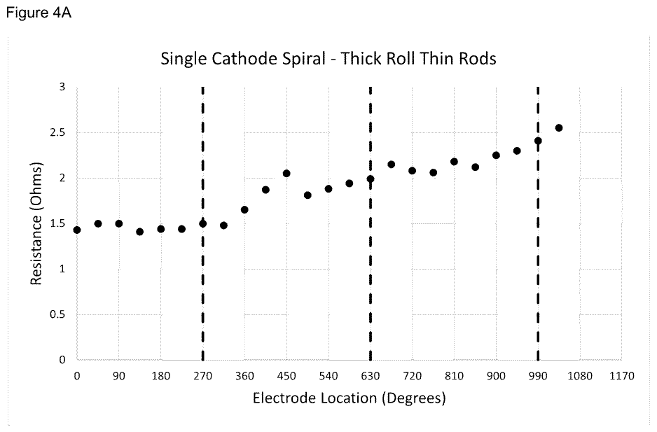

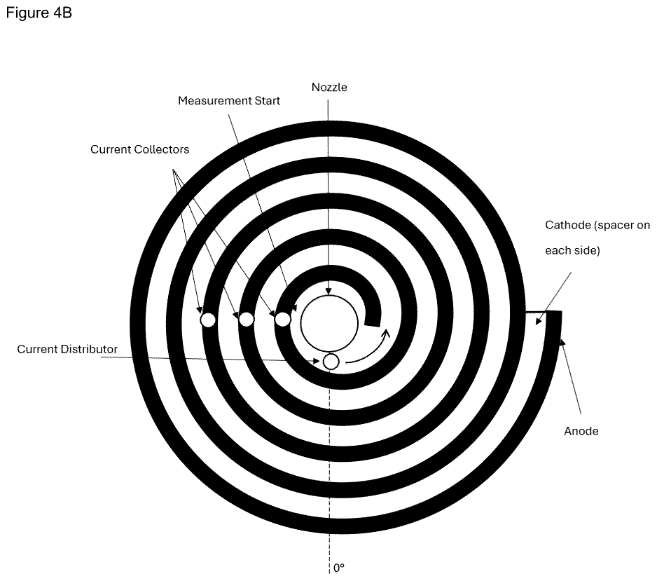

In the case of producing oxidizing species in the system of the anode electric potential needs to be as high as possible for a given applied voltage. If the voltage can be skewed towards a higher potential at the anode, then this benefits the production of oxidizers and therefore the destruction of micropollutants. By varying the amount and placement of current distributors into the AOS electrode roll the voltage distribution can be adjusted to favor these requirements. FIG. 4 shows the electrical potential at various locations within the electrode roll measured against an AglAgCl reference electrode. In FIG. 4 the position of the cathode roll rod was moved from position 1 to position 3 with anodes rods at positions 4, 5, and 6. Then 3 cathodes rods were placed so that there was one at each position 1, 2, and 3. The graph shows that as the cathode current distributor is moved further from the center of the roll the potential becomes more positive. The anode potential is stable around the entirety of the roll in each scenario with 3 cathode current distributors providing the highest positive anode potential between the configurations.

FIG. 4: a) Current distributor placement in a thick roll, b) Electrical potential going around the electrode roll with 2 V applied to the cell; C denotes cathode and A denotes anode. In the above case the potential is shown to be skewed since the anode potential differs from the cathode potential. Skewing towards the anode is a benefit since it increases the chance of producing oxidizing species formed at high positive potentials. Above it is also shown that positioning and the number of current distributors allows the voltage distribution to be adjusted.

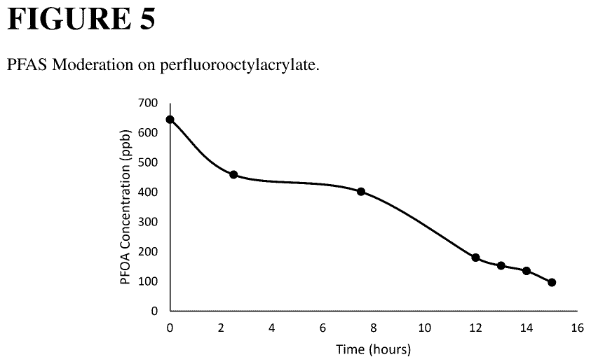

At higher voltages the electrical potential can skew past the midway point. For example, in FIG. 5 when 4 V is applied the anode potential is above 2 V and even exceeds 2.5 V when in the given current distributor configuration. This provides an increase in energy efficiency.

FIG. 5: a) Current distributor positions in the thick electrode roll, b) Voltage distribution curves for anode and cathode rolls at an applied 4 V. This can be utilized for any electrode length. FIG. 6 shows the two roll types currently available, labelled thick (7.5 mm thickness) and thin (2.5 mm thickness). The above voltage distribution effects can be found in both roll types. The thicknesses of each layer may be varied as between 2.0 and 50 mm as desired

FIG. 6: a) Thick Roll, b) Thin Roll

This arrangement enhances required oxidizing agent production while reducing the number of potential parasitic side reactions. The configuration and number of current distributors can be varied within 360 degrees of freedom and how close they are placed radially from the center. As described above this results in a change in the voltage distribution but also changes the resistance of the cell. Water conductivity can change depending on the location which will also change the cell resistance. Since the cell resistance can be adjusted it can be tailored to various water matrices to maintain operating parameters of voltage and current. For instance, it is possible to apply 2 V to the same roll diameter but get 1-10 A with varying number and position of CD's and CC's in a roll. FIG. 7 shows how the resistance changes when there are 3 CC's, and 1 CD positioned around the electrode roll. This provides the ability to have higher currents and current densities where higher electrochemical efficiency is needed.

FIG. 7: Resistance of the cell with 1 CD placed at increasingly further points along the electrode roll. In short, the ability to customize the potential distribution as well as cell resistance provides the ability to maintain cell operating parameters for various water compositions without sacrificing performance.
PFAS Moderation

FIG. 8 shows the long term effect of the present technology on mediation of PFAS, especially PFOA (perfluorooctylacrylate) over a period of hours without the addition of any precursor additions.
Disinfection

The current technology has also been shown to have an enhanced effect on the disinfection capabilities of the device, which can be done with a precursor addition option. Enhanced residence time, flow rate as well as type, amount and placement of current distributors, feeders and the electric potential control yield a significant decrease in precursor compound dosing concentrations, improving overall treatment efficacy. Precursors can be any compound such as but not limited to potassium iodide salt that can be electrochemically converted into a disinfection compound such as iodine. Furthermore, the system enables operation at higher flow rates without compromising performance, due to the optimized internal hydrodynamics. Notably, the device has demonstrated stable operation and maintained removal efficiency in water matrices in the presence of proteinaceous matter up to concentrations of 10 ppm, highlighting its robustness in complex feed streams. Proteins can act as precursor sinks, in the potassium iodide case, but can be mitigated with a higher concentration dose. At 17 L/min, 10 ppm peptone and 2 ppm Potassium Iodide the AOS was able to remove 5 logs of bacteria (E. coli) in RO water.
Carbon felt modifications that can be used (list is an example, there are more).

### 1. Indium Ion Modification

Indium ions (In³⁺) were used to modify graphite felt, increasing its surface roughness and specific surface area to 3.889 m²/g. This enhanced its electrochemical performance in iron-chromium redox flow batteries by improving charge transfer and electrocatalytic activity.

### 2. Step-by-Step Oxidative Activation (KMnO₄+Mixed Solution)

Graphite felt was oxidized in KMnO₄ followed by treatment in a 3:1 mixed activation solution, introducing oxygen-containing functional groups. This reduced charge transfer resistance and enhanced redox peak symmetry, improving reaction reversibility and energy efficiency by 7.47%.

### 3. O/N/S Trifunctional Doping With L-cysteine

Trifunctional doping with oxygen, nitrogen, and sulfur was achieved by adding L-cysteine directly into the electrolyte, forming —COOH, —NH₂, and —SH groups. This method increased catalytic activity and long-term durability in cerium-based redox flow batteries.

### 4. Nitrogen Functionalization via Ultrasonication With Dopamine

Nitrogen-functionalized graphite felt was prepared by ultrasonication-assisted self-polymerization of dopamine, followed by pyrolysis. This process improved wettability, reduced polarization, and increased VRFB energy efficiency from 69.2% to 75.5%.

### 5. Ammonia-Treated Nitrogen Doping

Graphite felt was heat-treated in NH₃ at 900° C., introducing nitrogen groups that improved electrical conductivity and wettability. The treated felt showed enhanced activity for both VO₂⁺/VO₂⁺ and V²⁺/V³⁺ redox couples, boosting energy efficiency to 86.47%.

### 6. Oxygen Functional Groups via O₂ Plasma+H₂O₂

A dual-step oxidative method using O₂ plasma followed by H₂O₂ introduced tunable oxygen groups (especially —COOH), which significantly reduced over 77 tential in vanadium redox flow batteries and improved energy efficiency by 8.2% at high current densities.

### 7. Li₄Ti₅O₁₂/TiO₂ Nanocomposite Coating

Li₄Ti₅O₁₂ and TiO₂ nanowires were grown hydrothermally on graphite felt, forming a uniform coating with oxygen vacancies. This provided more active sites, enhancing energy efficiency to 82.89% at 80 mA/cm² and 62.22% at 200 mA/cm².

1. A system for the removal and oxidation/reduction of contaminants from water in the absence of substantial oxidative/reductive chemicals comprising:
a solid housing;
the housing providing a) a volume within which concentrations of contaminants are moderated from contaminated water, and b) within the housing an enclosed direction for water flow from a water entry side to a water exit side of the housing;
within the volume of the housing is a core comprising c) a spiral wound pair of porous conductive fibrous layers of at least two different thicknesses acting as at least one set of electrodes as at least one pair of anodes and cathodes having an axis within the spiral wound pair, and within two distinct and opposed areas of the spiral wound pair of carbon felt layers d) the at least one pair of anodes and cathodes passing longitudinally from the water entry side to the water exit side;
the spiral wound pair of leafed carbon felt layers having multiple current distributors within the spiral wound pair of leafed carbon felt layers are configured to assist in distributing an even electric potential and/or field across the spiral wound pair of leafed carbon felt layers;
the housing having restraining walls surrounding the spiral wound pair of carbon felt layers, and having the water entry side and the water exit side at positions at ends of the axis of the spiral wound pair of leafed carbon felt layers; and
the distribution of the spiral wound pair of leafed carbon felt layers within the housing creating water flow paths in three directions, i) parallel to the axis from the water entry side towards the water exit side; ii) radially outwardly from the axis towards the restraining walls; and iii) radially inwardly from the restraining walls towards the axis.

2. The system of claim 1 wherein the at least one set of electrodes are connected to an alternating current or direct current source.

3. The system of claim 1 wherein multiple current collectors comprising conductive elements are distributed within the spiral wound pair of porous conductive fibrous layers which comprise leafed carbon felt layers to assist in distributing an even electric potential and field longitudinally and/or radially across the spiral wound pair of porous conductive fibrous which comprise leafed carbon felt layers.

4. The system of claim 1 wherein there is at least one current distributor on an anode for each two pairs of carbon felt layers.

5. The system of claim 1 wherein there is at least one anode-cathode current distributor pair for at least 80% of adjacent pairs of porous conductive fibrous layers.

6. The system of claim 1 wherein there is at least one pair of anode and cathode current distributors for each pair of two porous conductive fibrous layers.

7. The system of claim 1 wherein there are at least two anode and cathode current distributors for each pair of porous conductive fibrous layers comprising carbon felt layers.

8. The system of claim 1 wherein baffles are present within the housing to control direction of flow of contaminated water through the housing.

9. The system of claim 4 wherein baffles are present within the housing to control direction of flow of contaminated water through the housing.

10. A method for the removal and oxidation/reduction of contaminants from water in the absence of substantial oxidative/reductive chemicals using the system of claim 1 comprising:
applying voltage between the at least one set of anodes and cathodes;
passing contaminated water into the solid housing from the water entry side;
while maintaining the applied voltage, directing water through the three directions in the spiral wound pairs of porous conductive fibrous layers within the housing;
the current across the at least one set of anodes and cathodes generating oxidative and/or reductive species from the water; and
the generated oxidative and or reductive species respectively oxidates and/or reduces the contaminants in the water.

11. The method of claim 10 wherein the generated oxidative species oxidates the contaminants in the water.

12. The method of claim 10 wherein the generated reductive species reduces the contaminants in the water.

13. The method of claim 10 wherein the current within the spiral wound pairs of carbon felt are maintained at a rate of between 1.0 and 20.0 coulombs/second ±0.2 coulombs/second.

14. The method of claim 10 wherein at least one organic species within the contaminated water is reduced by at least 60% by weight in a single pass through the system.

15. A method for the removal and oxidation/reduction of contaminants from water in the absence of substantial oxidative/reductive chemicals using the system of claim 4 comprising:
applying voltage between the at least one set of anodes and cathodes;
passing contaminated water into the solid housing from the water entry side;
while maintaining the applied voltage, directing water through the three directions in the spiral wound pairs of porous conductive fibrous which comprise carbon felt layers within the housing;
the current across the at least one set of anodes and cathodes generating oxidative and/or reductive species from the water; and
the generated oxidative and or reductive species respectively oxidates and/or reduces the contaminants in the water.

16. A method for the removal and oxidation/reduction of contaminants from water in the absence of substantial oxidative/reductive chemicals using the system of claim 9 comprising:
applying voltage between the at least one set of anodes and cathodes;
passing contaminated water into the solid housing from the water entry side;
while maintaining the applied voltage, directing water through the three directions in the spiral wound pairs of porous conductive fibrous which comprise carbon felt layers within the housing;
the current across the at least one set of anodes and cathodes generating oxidative and/or reductive species from the water; and
the generated oxidative and or reductive species respectively oxidates and/or reduces the contaminants in the water.
